(19) United States
(12) Patent Application Publication
(10) Pub. No.: US 2003/0179844 A1
(43) Pub. Date: Sep. 25, 2003

(54) High-density power source (HDPS) utilizing decay heat and method thereof

(76) Inventor: Claudio Filippone, College Park, MD (US)

Correspondence Address: CLAUDIO FILIPPONE, 8708 48th PLACE, COLLEGE PARK, MD, 20740, US

(21) Appl. No.: 10/263,727

(22) Filed: Oct. 4, 2002

Related U.S. Application Data
(60) Provisional application No. 60/326,992, filed on Oct. 5, 2001.

(51) Int. Cl. G21C 7/00

(52) U.S. Cl. 376/208

(57) ABSTRACT

This invention describes an innovative miniaturized decay-heat engine formed by a closed-loop system powered by the spontaneous decay of radioisotopes emitting alpha particles. Said alpha particles are emitted inside a sealed and reinforced capsule or rod whose surfaces reach a relatively high temperature as a result of the capture of the alpha particles in the inner shell of said capsule. Radiation shielding is not a significant problem since alpha radiation is stopped by the materials encasing the capsule. The cladding material covering the alpha capsule or rod acts as the thermal interface and the radiation shield at the same time. This invention provides a power source for time duration significantly longer than any power system powered by fossil fuels with minimum weight. The unit is assembled in an ultra-compact package providing power from a few months to several years without need for refueling.

### BACKGROUND OF THE INVENTION

Thermionic Generators have been widely and effectively utilized as devices able to convert nuclear decay heat into electricity. The principles governing these technologies relay on thermocouple effects between junctions exposed to a temperature differential. Several patents on these devices have been developed over the last few decades. In order to produce significant power these devices are quite heavy and bulky. Miniaturized devices produce extremely low power level which might be all it is necessary for certain applications. For example, Power Chip™ is a solid-state device that uses small sandwich-like wafers to generate electricity from a temperature differential. The technology is closely related to Borealis proprietary Cool Chips™ technology. Borealis patent, titled “Process for Stampable Photoelectric Generator”, U.S. Pat. No. 6,239,356, was issued by the United States patent and Trademark Office on May 29th, 2001. A basic data search produced countless methods and apparatus for thermionic converters. For example, “Method and Apparatus for a Vacuum Thermionic converter” with thin film carbonaceous field emission, U.S. Pat. No. 6,064,137, and several other patents developed to decrease the work function of the materials forming the thermocouple junction to increase the electron efficiency. Most of these patents are centered on the utilization of decay heat to create a temperature differential between exotic junctions to produce electricity as efficiently as possible. All of these technologies, although very sophisticated, produce relatively bulky and relatively inefficient electric generators especially when the energy demand at their output is relatively high. The main objective of the present invention is to entirely by-pass the conversion of decay heat into electricity via thermocouple technologies. To achieve this objective a special heat exchanger in conjunction with a vapor cycle and a novel automatic cooling system for condensation is utilized to convert decay heat-to-fluid energy-to-electricity or mechanical work. This high-density power source is scaleable and can produce significant power output even when the unit is miniaturized.

### SUMMARY OF THE INVENTION

One or more sealed reinforced alpha decay-heated capsules or rods assembled inside a heat transfer mechanism formed by extended surfaces separated by a clearance become the heat source and the radiation shield of a closed-loop vapor cycle. An organic fluid, or any fluid with the proper thermal physical properties, is utilized as the expanding fluid inside said clearance. Once pressurized inside the clearance said fluid undergoes heat transfer with said extended surfaces in thermal contact with the decay-heated capsule or rod. The level of pressurization inside said clearance is proportional to the amount of decay heat available from the decaying isotopes. At this point high-pressure super-heated fluid is allowed to expand inside a vapor turbine, thereby converting the vapor energy into mechanical energy. Said vapor turbine is mechanically linked to a forced air/gas or liquid cooling system in thermal contact with compact condensers designed to condense said fluid once expanded through said vapor turbine. When the electric or mechanical load applied to the HDPS is minimum the decay-heated capsule(s) or rods are automatically cooled by an increased coolant flow forced by an air/gas compressor or liquid pump by means of an impeller driven by said vapor turbine. The output of this engine is shaft-work and electrical power scaleable in a manner proportional to the amount of alpha emitting isotopes, and for a duration proportional to the half-life of said alpha emitting isotopes. Isotopes can be generated as a result of neutron or ion bombardment, or they can be chemically extracted from spent nuclear fuel. If the alpha emitting isotope is also emitting other undesired forms of radiation such as gamma-rays or beta-rays, or a combination of said beta and gamma-rays, the unit can be equipped with additional shielding. Therefore, the unit is designed to safely operate with pure or almost pure alpha emitters, but can also be operated with isotopes having large probability of emission in the form of alpha particles and small probability of gamma or beta emission.

### BRIEF DESCRIPTION OF THE DRAWINGS

FIG. 1 Is a schematic representation of a cylindrical HDPS showing a preferential but not limiting disposition of one or more decay heated capsules or rods integrated inside a thermal-hydraulic closed loop wherein a fluid executes a vapor cycle.

FIG. 2 Is a simplified representation of the basic steps necessary to manufacture one capsule or rods containing a selected isotope with a desired half-life and radiation decay mode (i.e. alpha, beta, etc.).

FIG. 3 Is a schematic with a detailed description of the rotating components forming the power plant of the HDPS unit along with the cooling system.

FIG. 4 Is a schematic representation of a miniaturized configuration of the HDPS scaleable down to the size of a “fat” cigarette wherein all sub-components are self-contained.

### DESCRIPTION OF THE PREFERRED EMBODIMENTS

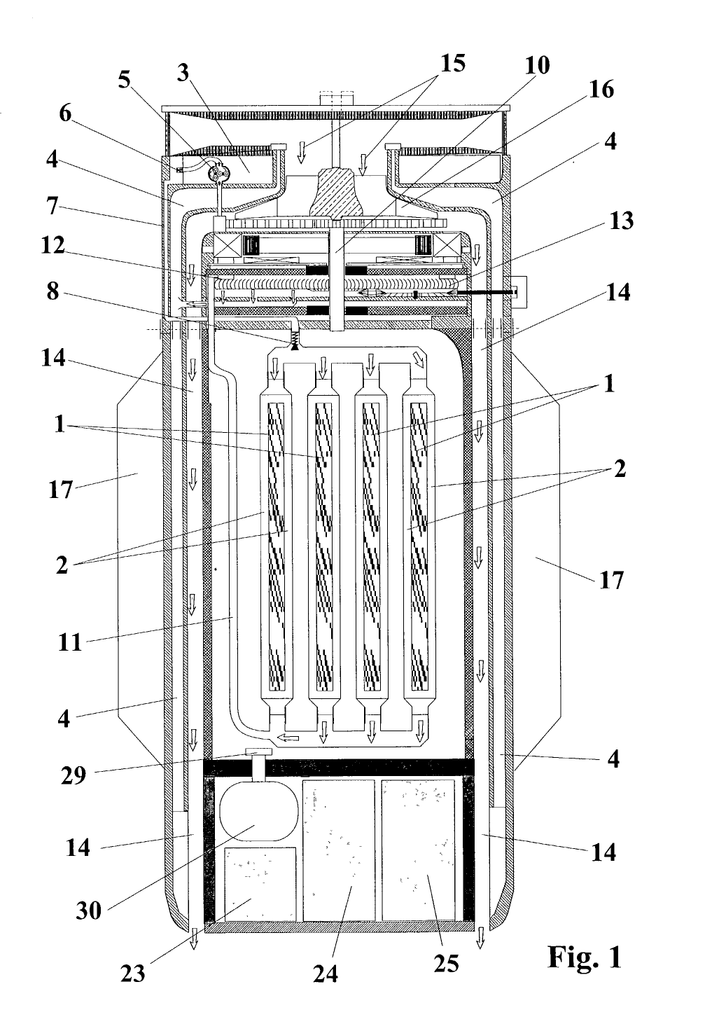

The working principles of the HDPS system are now described by utilizing the schematics and representations shown in FIGS. 1-4.

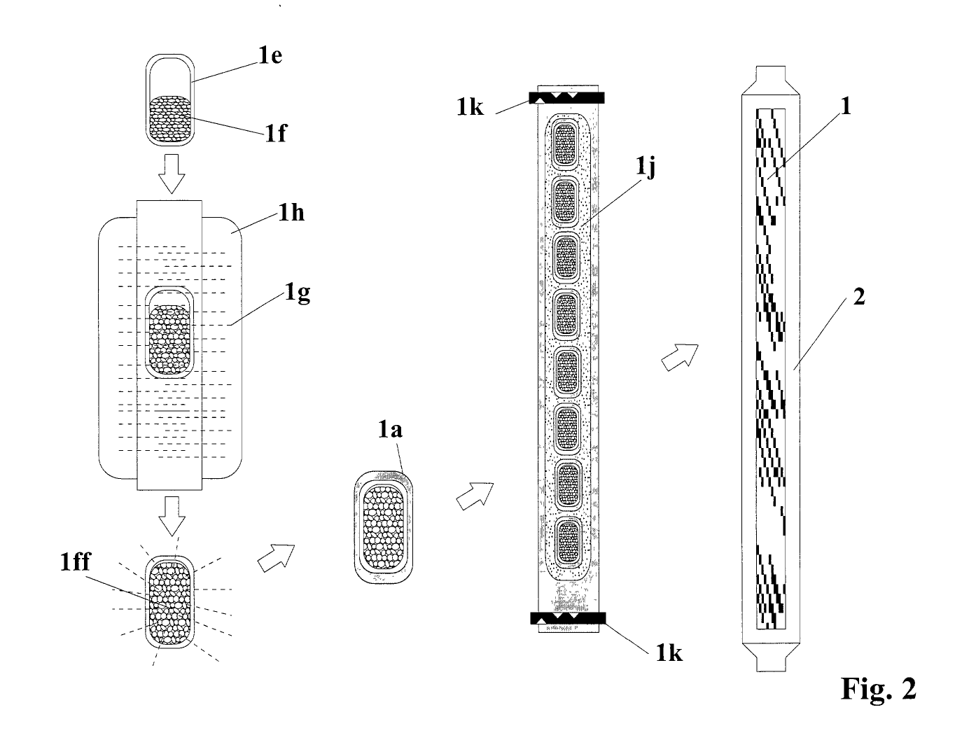

In FIG. 1, one or more decay-heating fuel elements 1, formed by sealed and reinforced pellets or capsules 1a (FIG. 2), containing a desired amount of nuclear decaying isotopes If (FIG. 2), are positioned inside a thermal hydraulic circuit 2. These fuel elements can be manufactured in any shape or dimension. Said fuel element(s) 1 are positioned inside said thermal-hydraulic circuit 2 such that between the surfaces of said fuel elements 1 and said thermal-hydraulic circuit 2 there is enough clearance to allow a fluid to expand while transiting inside said clearance. Said fluid is stored inside the storage tank 3 and inside the hydraulic path of the high efficiency condenser 4. Said fluid is compressed by pump 5, which can be submerged inside tank 3, or positioned anywhere in the unit as long as the suction of pump 5 is hydraulically connected with the hydraulic path indicated by number 4 in FIG. 1. Pump 5 is mechanically driven by a gear system 9 coupled with shaft 10. Once said fluid is pressurized at relatively high-pressure check valve 6 allows said fluid to flow inside hydraulic path 7 until it reaches one or more fluid injector(s) 8. At this point relatively cold fluid is forced to an intimate thermal contact with the outer surfaces of fuel element(s) 1 since said clearance, formed along hydraulic path 2, does not allow blankets of rapidly expanding vapor to shield the cold fluid. In other words, all of the cold fluid injected from injector 8 is exposed to a high heat transfer rate inside said clearance so as that all of said cold fluid is converted into superheated vapor. At the exit 11 of said thermal-hydraulic circuit 2 said superheated vapor is throttled via nozzle 12 so that it can expand through vapor turbine 13. The expanded vapor is now vented inside the closed-loop high efficiency condenser 4 where said vapor releases the remaining enthalpy of vaporization to the cooled surfaces of said high efficiency condensers 4. Once enough heat has been released said vapor condenses back to liquid fluid, thereby resetting the condition for a new vapor cycle. The heat rejection from the surfaces of said high efficiency condensers to the environment is accomplished mainly by convective heat transfer inside the coolant hydraulic path 14. This coolant indicated by arrows 15 can be air or any fluid provided that the blades of impeller 16 are proportionally shaped so as to add kinetic energy and pressure to a cooling fluid whether this is in a liquid or gaseous form. Another cooling mechanism of said high efficiency condensers is accomplished via conduction from the inner surfaces of path 4 to cooling fins 17 positioned along the circumference of the HDPS unit.

In FIG. 2 a decay-heated rod 1 formed by one or more alpha decaying capsule 1a is shown. A preferential but not limiting manufacturing method of the decay-heated capsule is achieved by considering a sealed capsule 1e containing an inert stable chemical such as the element “Bismuth” 1f in a desired amount. The sealed capsule 1e is formed by Aluminum or other materials able to withstand the high pressure developed inside the capsule once the materials in its inside become activated, and having extremely short half-life once exposed to a radiation field (i.e. neutron flux). This sealed capsule 1e is then exposed to a neutron flux 1g inside a nuclear reactor 1h for a an amount of time proportional to the amount of chemical 1f inside capsule 1e. The reactor 1h can be substituted with an accelerator in which case neutrons can be obtained through ion bombardment. After a certain time of exposure inside a radiation field the chemical 1f is transformed into a radioactive isotope which will decay via alpha radiation, thereby heating the capsule 1e. At this point isotope 1ff is liquid due to its much higher temperature. If the capsule 1e is formed by Aluminum it will take approximately 2 days for the Aluminum to become stable again. If the chemical 1f, once exposed to a neutron flux, becomes a pure alpha emitter the capsule will remain at high temperature for a time depending to the half-life of the activated chemicals. As an example if Bismuth-209 is utilized, the consequent alpha emitter is Polonium-210 which will decay into lead with a half-life of approximately 140 days. The thermal output of this isotope is approximately 140 W/g making it a remarkably compact heat source. Once the capsule 1e made of Aluminum, or any other material, becomes stable after the exposure inside a neutron field it is sintered inside a reinforced metal capsule 1a. The mechanical properties of this multi-shell capsule (or pellet) have to be able to withstand any kind of reasonable disruptive scenario (i.e. puncture, collision, explosion, high-temperatures etc.), since the alpha emitting isotope is extremely toxic. All manufacturing process must be executed by licensed operators and through the use of robotic equipment. One or more capsule 1a can now be inserted inside a rod 1 filled with an oil solution containing lead 1j, and weld shut at both ends 1k. The combination of multiple capsules 1a, scaleable in all dimensions, with the mechanical and radiation shield formed by the rod 1 cladding, forms a multiple barrier to rupture. The lead-oil solution 1j provides an optimum convective heat transfer mechanism, and a radiation shield for any gamma emitting impurities present in the chemical 1f prior irradiation. The pressure inside this system can reach elevated levels without jeopardizing the integrity of rod 1.

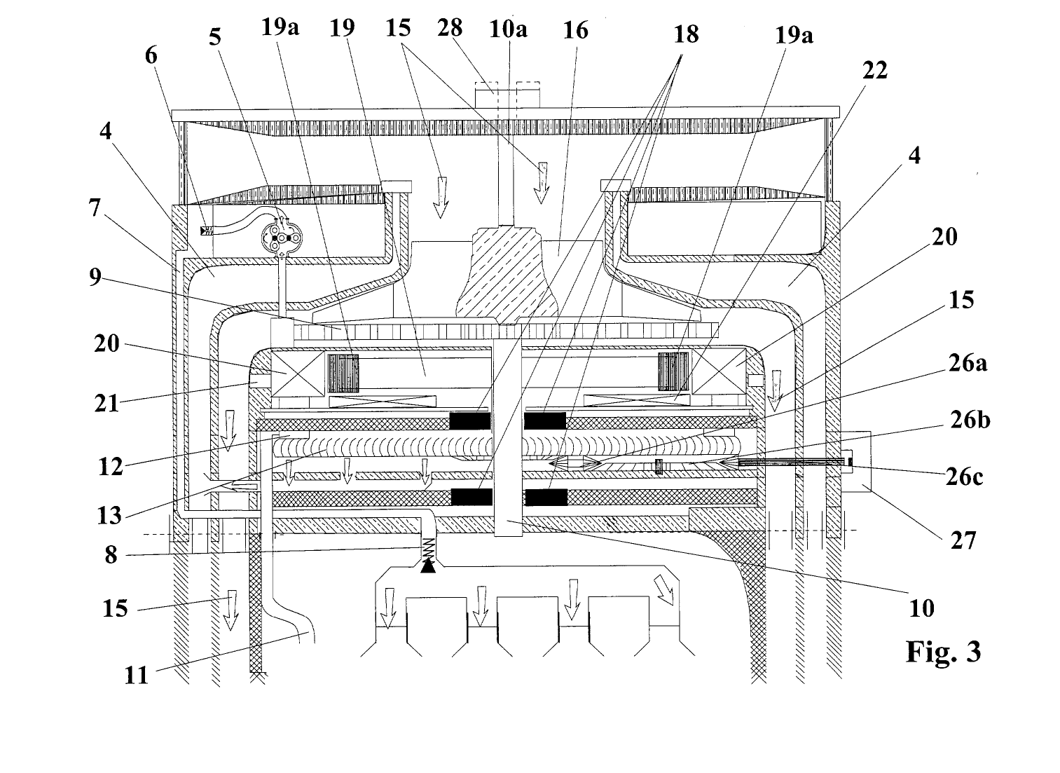

The power production system of the HDPS is described in FIG. 3. The vapor turbine 13 is mechanically linked to shaft 10 which is supported by the thrust bearings 18. Impeller 16 and the alternator rotor 19 are also mechanically linked to shaft 10. Rotor 19 contains compact magnets 19a magnetically coupled with stationary coils 20. When high-pressure vapor expands through the blades of vapor turbine 13 rotor 19 is set in motion generating an alternating magnetic field controlled by power switching components 21 driven by a centralized computer 22. This provides a controlled electric output utilized to charge one or more batteries 23, 24, and 25 at different voltages. The electric output can also be extracted from the HDPS unit without electronic control and batteries since these components can be positioned outside the unit. A mechanical output for mechanical actuation executable by the unit is represented by the gear system 26a, 26b, and 26c. A reduced low-rpm output is available at the mechanical coupler 27 while an unreduced high-rpm output is available at mechanical coupler 28 connected to shaft 10 via shaft 10a. Cooling of the HDPS unit is achieved as a function of load. When the electric or mechanical load is maximum, approximately 45% of the heat is converted into mechanical and electrical energy. The impeller 16 is designed with blades shaped so that at this maximum load condition the cooling fluid 15 (liquid or gaseous) provides enough mass flow rates to extract heat from the high-efficiency condensers 4 and reject it to the environment through concentric channel 14. When load is absent the speed of impeller 16 increases since all of the heat generated in the decay heated elements 1 is converted into mechanical energy at the vapor turbine 13. Automatically a larger mass flow of coolant 15 is forced into concentric channel 14 providing increased cooling for the excess heat. This mechanism assures automatic cooling of the decay heating elements 1 under all scenarios. If failures develop in any component of the cooling circuit a thermostatic valve 29 opens filling the environment surrounding the thermal-hydraulic circuit 2 with a highly conductive foam kept under pressure in pressurized tank 30. Even if tank 30 fails the heat transfer between the thermal-hydraulic circuit 2 and the cooling fins 17 is such that the decay heated rods 1 will remain at an equilibrium temperature which will not jeopardize the integrity of rods 1.

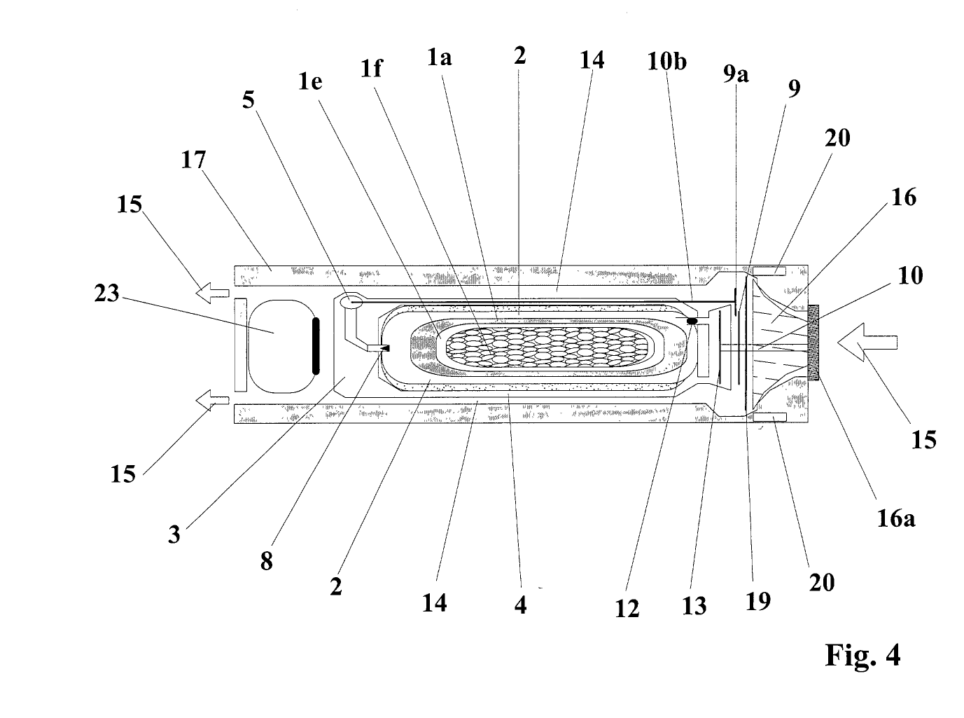

In FIG. 4 a miniaturized version of the HDPS unit is shown. In this figure one decay heat capsule la is contained inside a cylindrical structure which can reach the dimension of a cigarette. In this case vapor turbine 13 has a diameter in the same range of turbine for dentist equipment. The vapor cycle operates with the same principles described in FIG. 1. Fluid pump 5 is driven by a gear system 9 and 9a which brings shaft power to said pump 5 via shaft 10b. Pump 5 is submerged inside tank 3. High-pressure fluid is pumped through fluid injector 8 inside clearance 2 heated by the surfaces of capsule 1a. Superheated vapor flows through nozzle 12 and expands through vapor turbine 13 connected to shaft 10. Alternator rotor 19 is also driven by shaft 10. The permanent magnets (rare earth magnets) can also be embedded inside the impeller 16 so that an alternated magnetic path is formed by said magnets and stationary coils 20. Cooling fluid 15 goes through a filter 16a and inside the high-efficiency condenser clearance 14 where said expanded vapor condenses back to liquid and accumulates inside tank 3 again. Battery 23 is now approximately the size of a watch battery kept charged by the alternator system driven by the vapor turbine 13. The numbering utilized to indicate the same components consistently with FIG. 1. This terminates the description of the scaleable HDPS for high-density power production without need for re-fueling or recharging for several months up to several years depending on which isotope is selected as the fuel of the decay heated capsule.

What is claimed is:

1- A high-density scaleable power source utilizing decay heat configured to produce electric energy and shaft work, the system comprising:
At least one or more decay-heating fuel elements;
At least one thermal hydraulic path containing said decay-heating fuel element(s);
At least one expanding fluid stored inside at least one storage tank connected to said thermal hydraulic path;
At least one compressing pump;
At least one high-pressure check-valve to allow said expanding fluid to flow inside said thermal-hydraulic path;
At least one or more fluid injector(s);
At least one clearance formed by the outer surfaces of said decay-heat fuel element(s) and the inner surfaces of said thermal-hydraulic path converting said expanding fluid into superheated vapor;
At least one nozzle for said superheated vapor to expand through a vapor turbine converting said superheated vapor into mechanical energy and vapor;
At least one closed-loop high efficiency condenser formed by surfaces cooled by a gaseous or liquid coolant wherein said vapor condenses on contact with said surfaces;
One or more thrust bearings supporting a drive shaft 18.
At least one impeller connected to said drive shaft;
At least one alternator rotor connected to said drive shaft;
At least one said vapor turbine connected to said drive shaft;
At least one rechargeable battery;
At least one mechanical coupler for external power actuation;
A gear system connected to said mechanical coupler;
At least one thermostatic valve allowing conductive foam to cool said decay-heat fuel elements.

2- A high-density scaleable power source utilizing decay heat as defined in claim 1, wherein said decay-heat fuel elements are formed by sealed and reinforced pellets or capsules containing a desired amount of nuclear decaying isotopes.

3- A high-density scaleable power source utilizing decay heat as defined in claim 1, wherein said nuclear decaying isotopes are formed via neutron bombardment.

4- A high-density scaleable power source utilizing decay heat as defined in claim 1, wherein said nuclear decaying isotopes are formed via ion bombardment.

5- A high-density scaleable power source utilizing decay heat as defined in claim 1, wherein said nuclear decaying isotopes are formed via chemical extraction from radioactive materials.

6- A high-density scaleable power source utilizing decay heat as defined in claim 1, wherein said reinforced capsules or pellets are packaged inside a rod containing a solution to increase heat transfer and radiation shielding from said reinforced capsules or pellets and said rod.

7- A high-density scaleable power source utilizing decay heat as defined in claim 1, wherein said thermal-hydraulic circuit contains said decay-heat fuel elements positioned so that between the outer surfaces of said decay-heat fuel elements and the inner surfaces of said thermal-hydraulic circuit there is enough clearance to allow a fluid to expand while transiting inside said clearance.

8- A high-density scaleable power source utilizing decay heat as defined in claim 1, wherein said compressing pump can be submerged inside a storage tank positioned anywhere in the unit as long as the suction of said pump is hydraulically connected with thermal hydraulic circuit.

9- A high-density scaleable power source utilizing decay heat as defined in claim 8, wherein said compressing pump is mechanically driven by a gear system coupled with said drive shaft.

10- A high-density scaleable power source utilizing decay heat as defined in claim 1, wherein said high efficiency condensers are formed by surfaces cooled on one side by an external coolant while its inner closed-loop surfaces allow said vapor to condense back to liquid.

11- A high-density scaleable power source utilizing decay heat as defined in claim 10, wherein said coolant can be gas, liquid, or any fluid provided that the blades of said impeller are shaped accordingly with the choice of said coolant.

12- A high-density scaleable power source utilizing decay heat as defined in claim 10, wherein another cooling mechanism of said high efficiency condensers is accomplished via conduction to cooling fins positioned along the circumference of the HDPS unit.

13- A high-density scaleable power source utilizing decay heat as defined in claim 1, wherein said alternator rotor contains compact magnets magnetically coupled with stationary coils positioned in the vicinity of said alternator rotor.

14- A high-density scaleable power source utilizing decay heat as defined in claim 1, wherein said rotor can be embedded with said vapor turbine.

15- A high-density scaleable power source utilizing decay heat as defined in claim 1, wherein the alternating magnetic field generated by said alternator rotor and said stationary coils is controlled by a centralized computer by means of power switching components.

16- A high-density scaleable power source utilizing decay heat as defined in claim 1, wherein said battery is charged by said power switching components controlled by said centralized computer.

17- A high-density scaleable power source utilizing decay heat as defined in claim 1, wherein said gears are mechanically connected to a mechanical coupler.

18- A high-density scaleable power source utilizing decay heat as defined in claim 1, wherein cooling of the HDPS unit is achieved automatically as a function of load

19- A high-density scaleable power source utilizing decay heat as defined in claim 1, wherein said thermostatic valve allows to fill the environment surrounding said thermal-hydraulic circuit with a highly conductive foam kept under pressure in pressurized tank.

20- The method of extracting electric power from decay-heating isotopes by means of a scaleable power source comprising:
At least one or more decay-heating fuel elements;
At least one thermal hydraulic path containing said decay-heating fuel element(s);
At least one expanding fluid stored inside at least one storage tank connected to said thermal hydraulic path;
At least one compressing pump;
At least one high-pressure check-valve to allow said expanding fluid to flow inside said thermal-hydraulic path;
At least one or more fluid injector(s);
At least one clearance formed by the outer surfaces of said decay-heat fuel element(s) and the inner surfaces of said thermal-hydraulic;
At least one nozzle for superheated vapor to expand through a vapor turbine converting said superheated vapor into mechanical energy and discharging vapor inside a closed loop;
At least one closed-loop high efficiency condenser formed by surfaces cooled by a gaseous or liquid coolant wherein said vapor condenses on contact with said surfaces;
One or more thrust bearings supporting a drive shaft 18.
At least one impeller connected to said drive shaft;
At least one alternator rotor connected to said drive shaft;
At least one said vapor turbine connected to said drive shaft;
At least one rechargeable battery;
At least one mechanical coupler for external power actuation;
A gear system connected to said mechanical coupler;
At least one thermostatic valve allowing conductive foam to cool said decay-heat fuel elements.
At least one said coolant inlet
At least one said coolant outlet
A cooling fin system positioned and in thermal contact with the HDPS unit.
